(19) United States
(12) Patent Application Publication
(10) Pub. No.: US 2008/0178536 A1
(43) Pub. Date: Jul. 31, 2008

(54) Superabrasive Coatings

(76) Inventor: Edward C. Johnson, West Hartford, CT (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/872,624

(22) Filed: Oct. 15, 2007

Related U.S. Application Data
(63) Continuation of application No. PCT/US06/14098, filed on Apr. 14, 2006.
(60) Provisional application No. 60/671,231, filed on Apr. 14, 2005.

(51) Int. Cl. C09K 3/14; B05D 3/00

(52) U.S. Cl. 51/298; 51/297; 427/387

(57) ABSTRACT

The present invention relates to a method for producing an abrasive. The abrasive is embedded into silazane resin that has been coated onto a work surface. The abrasive may include abrasive particles such as diamond or cubic boric nitride and may additionally include silazane resin which is then embedded in the silazane resin coating.

### CROSS REFERENCE TO RELATED APPLICATIONS

The present application is a continuation of International Application No. PCT/US2006/014098 filed Apr. 14, 2006 and published Oct. 26, 2006 as International Publication No. WO 2006/113447, designating the United States, and which claims benefit of the filing date of U.S. Provisional Application Ser. No. 60/671,231 filed Apr. 14, 2005, the teachings of which are incorporated herein by reference.

### FIELD OF INVENTION

The present invention relates to an abrasive and a method of producing abrasive coatings. More particularly, the present invention relates to an abrasive and a method of producing abrasive coatings using silazane polymers and silazane polymer blends as a resin binder.

### BACKGROUND

In particular, amongst other materials, cubic boron nitride and diamond are commonly used in abrasive applications. Diamond is reportedly the hardest known material in the world. Second to diamond is cubic boron nitride. There are a number of known methods to incorporate these materials, as well as other abrasive materials into abrasive products. These methods include the use of binders or electroplating to affix the abrasives into or onto a solid form.

Abrasives have been incorporated into a number of binders including polymer resins and metal powders. For example, it is known to use polysilazane and polyureasilizane as polymer resin binders in grinding wheels and other applications requiring abrading materials. U.S. Pat. No. 5,884,688 discloses the use of organometallic ceramic precursor binders to fabricate shaped bodies. The patent identifies polysilazane and polyureasilazane as precursor binders into which sand may be incorporated. U.S. Pat. No. 5,641,817 is another example that reports the use of organometallic ceramic precursor binders, including silazanes, to fabricate shaped bodies, including grinding wheels, by different techniques. Japanese Patent Application No. 62-107218 also discloses a method of producing an abrasive, that may be used in grinding applications, utilizing polysilazane as a binder resin incorporating abrasives that include natural or synthetic diamond, emery, Carborundum, etc.

Electroplating has also been used to incorporate abrasive materials into abrasive products. U.S. Pat. No. 6,755,619 discuses the entrapment of abrasive particles onto the tip of a turbine engine blade by electrodepositing a matrix based on Cr, Co, Ni and alloys of such. U.S. Pat. No. 4,180,048 discloses a cutting wheel for semiconductors having a thin disc consisting of finely divided abrasive particles embedded in a nickel matrix which is overlaid with chromium by electrodeposition. U.S. Pat. No. 4,155,721 teaches pre-etching a metallic work piece. The work piece is then placed into a bath containing an aqueous solution of metal ions into which abrasive particles are then introduced. The particles are then caused to be embedded in the etched surface by a metal anode. Then the work piece is plated partially embedding the abrasive particles.

While the above certainly contribute to the available methods of producing abrasive products, there is nonetheless a need to improve on the above, particularly with respect to increasing the flexibility in using silazane resin in abrasive applications. Accordingly, it is one object of the present invention to provide methods to produce abrasive products utilizing silazane resin. It is also an object of the present invention to provide a method applying abrasive materials to desired work pieces. Furthermore, it is an object of the present invention to produce an abrasive product that prevents the build up of grinding residue between the abrasive particles and is capable of providing self-lubrication.

### SUMMARY

In a first exemplary embodiment the present invention is directed at a method for abrasive coating a selected area of an object comprising providing an object to be coated, wherein the object has a selected area to be coated, applying a first silazane resin to the selected area of the object and curing the silazane resin to the selected area of the object.

In another exemplary embodiment of the present invention a method for abrasive coating a selected area of an object via the use of a premolded form comprising providing a mold to create a premolded form; providing a silazane resin and abrasive and placing in the mold to create the premolded form; curing the silazane resin and abrasive; supplying an object with an area to be coated and applying silazane resin to the area to form a coated area; placing the premolded form on the coated area; and bonding the premolded form to the coated area.

### BRIEF DESCRIPTION OF DRAWINGS

FIG. 1 illustrates a cross-sectional view of an exemplary embodiment of the present invention.

FIG. 2 illustrates a cross-sectional view of an exemplary embodiment of the present invention.

FIG. 3 illustrates a cross-sectional view of an exemplary embodiment of the present invention.

### DETAILED DESCRIPTION

The present invention relates to abrasive products and methods of producing abrasive products. More particularly, the present invention relates to an abrasive product and a method of producing abrasives using resins such as silazane polymers and silazane polymer blends as a binder.

In one embodiment of the present invention a silazane resin coating may be deposited onto a work surface. Preferably, the silazane resin may be a polysilazane, a polycarbosilane or a polyureasilazane. In one embodiment, the silizane may be sourced from Kion Corp., Huntingdon Valley, Pa. Abrasive particles may be premixed into the coating, or may be placed onto the work surface prior to or subsequent to the application of the coating. Preferably, the abrasive particles may be any abrasive particle such as diamonds, cubic boron nitride, silicon carbide, aluminum oxide or emery. The silazane resin may then be cured with the abrasive particles incorporated either wholly or partially therein.

In another embodiment of the present invention, an abrasive may be entrapped via electroplating to a work piece surface. The substrate surface may be pretreated mechanically or with acid and then may be electroplated to entrap an abrasive. In one embodiment, electroless nickel plating may be used. The silazane resin may then be coated onto the surface of the plated abrasive. Then silazane resin may be cured by sintering or pre-cured by heating. It should be appreciated that in one embodiment, the work piece may be a grinding wheel and the work piece surface may be the grinding surface of the grinding wheel, however the present invention should not be limited to grinding wheels, as other surfaces, such as those of tools, aircraft engine blade tips and other abrasive products are contemplated by the present disclosure.

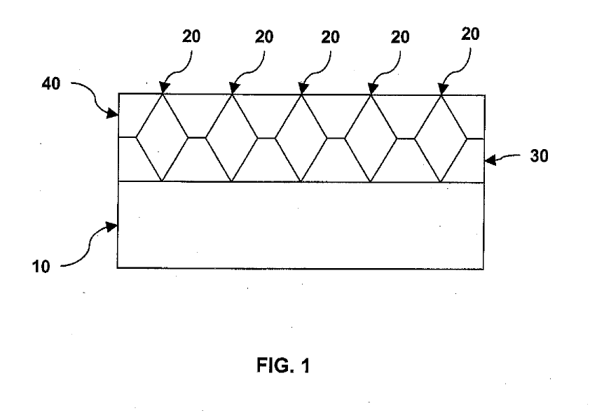

An exemplary embodiment of the present invention is illustrated in FIG. 1. A work surface 10, such as a grinding wheel, may be provided. Abrasive particles 20 may be electroplated to the work surface 10, forming an electroplated surface 30. Silizane resin 40 may then be coated onto the abrasive particles 20 and electroplated surface 30.

Preferably, the electroplating 30 may entrap the abrasive particles 20 between 10-95% depth and values and incremental values in between. More preferably, the abrasive particles may be entrapped between 30-80% depth, and most preferably between 40-70% depth. Preferably, metals such as nickel, chromium, copper or alloys thereof may be plated onto the work surface. In one embodiment, gold, silver and brass may also be used or incorporated into an alloy and plated onto the work surface.

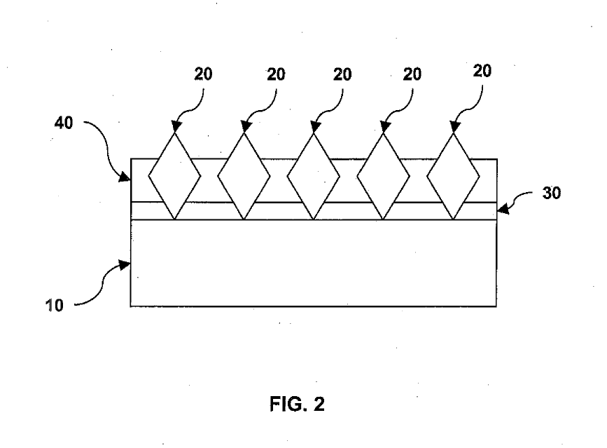

Illustrated in FIG. 2, is another embodiment of the present invention. Silazane resin 30 may be coated onto the work piece surface 10. Abrasive particles 20 may be then applied to the silazane resin 30. The silazane resin 30 may be then precured to tack the abrasive particles in place. If desired, further layers of silazane polymer and abrasive particles may be added 40 and tacked in place. After accumulating the desired number of layers the silazane may then be cured.

In another embodiment of the present invention, the silazane resin may be coated onto an aircraft engine blade tip or knife edge seal in a thin layer. In one embodiment, the coating may be between about 0.0005 inches and 0.015 inches, and all increments therebetween including 0.0015 inches, 0.003 inches, etc. Abrasive particles may then be applied to the uncured silazane resin. The silazane resin may be then pre-cured to tack the abrasive particles in place. If desired, further layers of silazane polymer and abrasive particles may be added and tacked in place. After accumulating the desired number of layers the silazane may then be cured to form a ceramic material incorporating the abrasives. The abrasive coated tip then may be capable of grinding itself into the outer seal, improving the gas seal between the rotating blade and the stationary outer case of the aircraft engine.

In one embodiment of the present invention, abrasive particles may be incorporated into the silazane polymer. The silazane polymer/abrasive material may be molded under pressure in a heated mold where it may be cured to form the abrasive. Preferably, the polymer/abrasive material may be molded into the desired work piece. Silazane resin may be then coated onto another piece to which the work piece may be fixtured. Then the pieces may be cured together to form a unitary piece.

In another embodiment, abrasives may be incorporated into the silazane polymer creating an abrasive. The silazane polymer/abrasive material may be molded under pressure in a heated mold designed to create a finished part that fits onto the tip of the aircraft blade. The molding process can be done at temperatures of about 200° C., or to about 1000° C. Silazane resin may be then coated onto the blade tip to which the molded piece may then be fixtured. The blade can then be heated to a pre-cured/thermoset state or to a cured ceramic state forming a unitary piece.

In one embodiment the silazane resin may also be coated as a paste. The paste may include powders such as graphite, molybdenum, Teflon and ceramics. It should be appreciated that the viscosity of the paste may be varied with the desired application. The silazane resin may also be coated as a liquid. Once in the form of a liquid, the silazane resin may be applied using methods such as, but not limited to, rolling, spraying, brushing, etc.

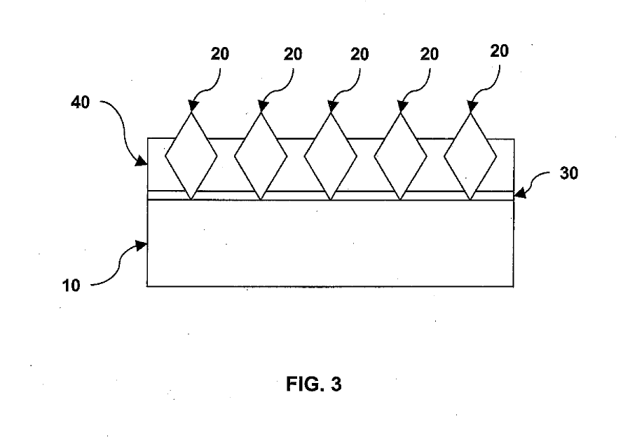

One exemplary embodiment is illustrated in FIG. 3. A work surface 10, such as an aircraft engine blade, may be provided to which a silazane adhesive layer 30 may be coated. The adhesive 30 may be applied in either paste or liquid form. Once the adhesive 30 may be coated onto the work surface 10, abrasive particles 20 may be applied. However it should be appreciated that the abrasive particles may also be mixed into the adhesive prior to applying the adhesive. This layer may be cured or pre-cured to adhere the abrasive particles 20 to the work surface. Then a silazane layer 40 may be applied onto the adhesive layer 30, which may be cured to the structure as well.

In one embodiment, curing may occur at temperatures between about 200-2000 degrees Celsius and all incremental values therebetween including 500 degrees Celsius, 1000 degrees Celsius, 1500 degrees Celsius, etc. Furthermore, the curing may occur for a duration of about 30 minutes to 10 hours, including but not limited to 25 minutes, 1 hour, 5 hours, etc. In addition, heat treatment may occur in various environments including air, argon, nitrogen, ammonia. It should be appreciated that the nature of the ceramic produced may change according to the environment in which curing occurs.

In another embodiment, the silazane resin may be cured at temperatures between about 100-1500° C., and any temperatures there between. In one embodiment, the resin may be cured at temperatures of about 200° C. In another embodiment, the resin may be cured at temperatures of about 700° C. In yet another embodiment, the resin may be cured at temperatures of about 1000° C. It should also be appreciated that the silazane resin may be pre-cured at temperatures of about 200° C. It should also be appreciated that when curing the silazane resin at temperatures of about 450° C. or above and to about 1500° C. the resin may be pyrolyzed.

In addition, heat treatment may occur in various environments including air, argon, nitrogen, ammonia. It should be appreciated by one skilled in the art that variation in atmosphere may lead to a variation in the nature of the ceramic produced. In one embodiment, using an argon atmosphere a silicon carbide ceramic may be produced. In another embodiment, using an ammonia environment a silicon nitride may be produced.

Furthermore, in another embodiment, when the resin may be cured at temperatures of about 200° C. the polymer may become a thermoset polymer. In another embodiment, the resin may be cured at temperatures of about 500-1500° C. and may then be in a ceramic state.

In one embodiment of the present invention, various particles may be incorporated into the silizane polymer. These materials include lubricating powders, metal powders, carbon microfibers, nanotubes and abrasives. It should be appreciated that the type and amount of these particles may vary depending upon the desired property, including but not limited to thermal stability and wear resistance of the molded abrasive form.

In another embodiment, a lubricant may be incorporated into the silazane resin coating. Preferably, the lubricant may include a fluoropolymers such as polytetrafluoroethylene. Polytetrafluoroethylene, otherwise known as PTFE, may be obtained from DuPont Fluoropolymers, CRP 705/GS29 4417. Lancaster Pike Wilmington, Del. 19805 and is sold under the trade name Teflon®. The lubricant may also include, but may not be limited to, graphite, molybdenum disulfide or boron nitride.

In another embodiment of the present invention, additives may be incorporated in the silazane polymer to improve the toughness and integrity of the coating. Preferably, the additives may include micronized ceramic powders, such as aluminum oxide, or carbon microfibers or carbon nanotubes.

It should be appreciated by those skilled in the art that the methods contemplated may be amenable to field repairs.

The foregoing description is provided to illustrate and explain the present invention. However, the description hereinabove should not be considered to limit the scope of the invention set forth in the claims appended here to.

What is claimed is:

1. A method for coating a selected area of an object comprising:
providing an object to be coated, wherein the object has a selected area to be coated;
applying a first silazane resin to said selected area of said object; and
curing said silazane resin to said selected area of said object.

2. The method of claim 1 including the step of combining an abrasive with said silazane resin.

3. The method of claim 1 wherein said curing is at a temperature of about 200° C.-1000° C.

4. The method of claim 1 wherein said first silazane resin is selected from the group consisting of polycarbosilanes, polysilazane and polyureasilazane.

5. The method of claim 1 wherein said silazane resin comprises a lubricant.

6. The method of claim 2 wherein said abrasive is selected from the group consisting of diamond, cubic boron nitride, silicon carbide, aluminum oxide, emery and mixtures thereof.

7. The method of claim 1 including the step of curing said silazane resin and providing a second silazane resin and applying said second resin to said cured first silazane resin.

8. The method of claim 7 wherein said first silazane resin or said second silazane resin includes a lubricant.

9. The method of claim 1 wherein said curing of said silazane resin is carried out at a temperature of about 200° C.-400° C.

10. The method of claim 7 wherein said second silazane resin is selected from the group consisting of polycarbosilane, polysilazane and polyureasilazane.

11. The method of claim 7 wherein said selected area of said object is an edge of said object.

12. The method of claim 11 wherein said object is an aircraft engine blade and said edge of said object is an edge of the blade.

13. The method of claim 1, wherein said object to be coated includes an abrasive protruding from said selected area.

14. The method of claim 13, wherein said abrasive is electroplated onto said object.

15. The method of claim 14, wherein said object is a grinding wheel.

16. The method of claim 13, wherein said abrasive is electroplated onto said object at a depth of approximately 40-70%.

17. The method of claim 1, further comprising curing said silazane resin in an environment selected from the group consisting of air, argon, nitrogen, and ammonia.

18. The method of claim 1, wherein said silazane resin comprises an additive selected from the group consisting of lubricating powders, metal powders, carbon microfibers, nanotubes, abrasives, micronized ceramic powders molybdenum, Teflon, ceramics, graphite, boron nitride, molybdenum disulfide, and mixtures thereof.

19. The method of claim 7, wherein said silazane resin comprises an additive selected from the group consisting of lubricating powders, metal powders, carbon microfibers, nanotubes, abrasives, micronized ceramic powders molybdenum, Teflon, ceramics, graphite, boron nitride, molybdenum disulfide, and mixtures thereof.

20. A method for abrasive coating a selected area of an object via the use of a premolded form comprising:
providing a mold to create a premolded form;
providing a silazane resin and abrasive and placing in said mold to create said premolded form;
curing said silazane resin and abrasive;
supplying an object with an area to be coated and applying silazane resin to said area to form a coated area;
placing said premolded form on said coated area; and
bonding said premolded form to said coated area.

21. The method of claim 13 wherein said curing of said silazane resin and abrasive is at a temperature of about 200° C.-1000° C.

22. The method of claim 13 wherein said object with an area to be coated comprises an aircraft engine blade and said area to be coated comprises an edge of said blade.
